(19) United States
(12) Patent Application Publication
(10) Pub. No.: US 2021/0241316 A1
(43) Pub. Date: Aug. 5, 2021

(54) Method and System for Managing Privacy Compliance

(71) Applicant: Trident Corporate Services (Singapore) PTE Limited as Trustee for the Oneplace Unit Trust, Singapore (SG)

(72) Inventor: Timothy Julien SMITH, Singapore (SG)

(73) Assignee: Trident Corporate Services (Singapore) PTE Limited as Trustee for the Oneplace Unit Trust, Singapore (SG)

(21) Appl. No.: 17/049,466

(22) PCT Filed: Apr. 15, 2019
(86) PCT No.: PCT/SG2019/050208

§ 371 Date: Oct. 21, 2020

(30) Foreign Application Priority Data
Apr. 23, 2018 (SG) 10201803395Y

(51) Int. Cl. G06Q 30/02

(52) U.S. Cl. CPC G06Q 30/0258; G06Q 30/0277

(57) ABSTRACT

A method and system of managing a client record for a client record management system, including accessing a database of client records, retrieving a list of non-compliant client records and displaying this, filtered by a category where a non-compliant client record can be selected for a template email to be sent, and receiving a reply that includes a consent, with a subsequent communication is sent to the email address.

### TECHNICAL FIELD

The present invention relates to a method and system for the management of client records in terms of privacy compliance. More specifically, the present invention relates to ensuring customer accord is obtained.

### BACKGROUND

Within a record management system for understanding and communicating with clients, both prospective and past, contacts and the like, client records are populated with information that can be used by the users for various purposes. A part of the marketing effort includes invitations to firm functions, sending materials, informational updates, alerts, or newsletters. Given the proliferation of electronic messaging and mailers as well as emails, it has become easy to send out such marketing efforts quickly and efficiently. However, this can give rise to a deluge of incoming correspondence for the recipient and lead to these being filtered out unread. It would be better to send tailored marketing material that is meant for the target recipient and who would find the information useful.

There is a need to comply with privacy legislation such as the Canadian Anti-Spam Registration (CASL), the Singapore Personal Data Protection Act (PDPA), and the General Data Protection Regulations (GDPR), just to name a few. These laws are country or region specific, and specify the type of consent that must be acquired from a recipient before marketing efforts can be sent to the recipient. Some laws also specify that any consent given is only for a specified time period; after which consent has to be sought again.

Thus a client data processing management system and method that is able to overcome these issues and that is able to manage the process of outreach efforts in an efficient manner.

### SUMMARY

The above and other problems are solved and an improvement in the art is made by a method and system in accordance with this invention. A first advantage of the method and system in accordance with this invention is that consent to being on the mailing list for marketing materials is managed and automated. This allows a firm to manage a large volume of clients and disseminates information and advertising to a group of willing clients. A second advantage of the method and system in accordance with this invention is that the marketing effort can be tailored for each client. This ensures that the information being sent to the client is relevant for their needs and expectations. A third advantage of the method and system in accordance with this invention is that it ensures that the firm fulfils its legal requirements in relation to privacy laws.

The present invention provides a system and method for client consent for a client record management system. In one embodiment in accordance with the invention, there is a method of managing a client record for a client record management system, the method comprising accessing a database of a plurality of client records, retrieving a list of non-compliant client records, displaying the list of non-compliant client records filtered by a category, selecting at least a non-compliant client record, sending a template email to an email address in the non-compliant client record, receiving a reply based on the template email, where the reply includes a consent, and a subsequent communication is sent to the email address. In a further embodiment, the subsequent communication is a confirmatory email. In yet a further embodiment, the subsequent communication includes a questionnaire to determine an interest area and to update the database based on a response. In an alternative embodiment, the template email includes a questionnaire to determine an interest area and to update the database based on a response. In yet another embodiment, the category is one of: by region, by country, by area, by city or by state. In a further embodiment of the invention the list of non-compliant client records is based on a field in each client record corresponding to a time period of days since the consent was obtained. In yet a further embodiment of the invention also includes a display corresponding to the time period wherein the display includes a number and is highlighted using a colour, font, or style.

In accordance with an embodiment, there is a system of managing a client record for a client record management system, the system comprising a client record management system including a processor and memory, a database module including a processor and memory configured to process and store a plurality of client records, a data processing system including a data processor and a data memory, the data processing system configured to access a database of a plurality of client records to retrieve a list of non-compliant client records, display the list of non-compliant client records filtered by a category, select at least a non-compliant client record, send a template email to an email address on the sub-list of non-compliant client records, receive a reply based on the template email, where the reply includes a consent, and a subsequent communication is sent to the email address. In further embodiments, the subsequent communication is a confirmatory email. In yet further embodiments, the subsequent communication can include a questionnaire to determine an interest area and to update the database based on a response. In alternative embodiments, the template email includes a questionnaire to determine an interest area and to update the database based on a response. In yet other embodiments, the category is one of: by region, by country, by area, by city or by state. In further embodiments, the list of non-compliant client records is based on a field in each client record corresponding to a time period of days since the consent was obtained. In alternative embodiments of the invention, the system also includes a display corresponding to the time period wherein the display includes a number and is highlighted using a colour, font, or style.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements.

FIG. 1 illustrates a representation of a network of data processing systems in which aspects of the disclosed embodiments may be implemented;

FIG. 2 illustrates a schematic view of a software system for carrying out an embodiment;

FIG. 3 illustrates a method of managing privacy compliance in accordance with an embodiment of the invention.

### DETAILED DESCRIPTION

The various configurations discussed in these non-limiting examples can be varied and are used to illustrate at least one embodiment and are not intended to limit the scope thereof.

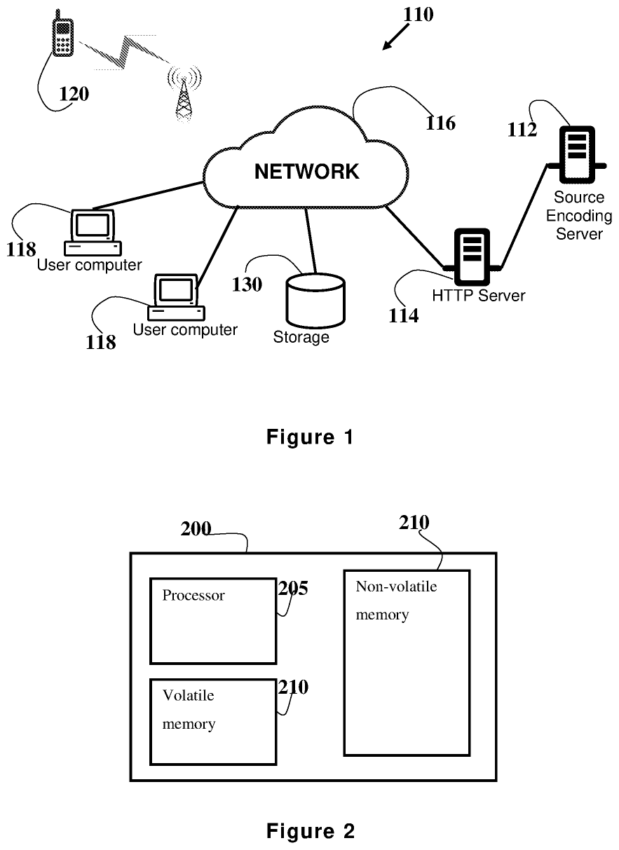

FIG. 1 shows a record system in accordance with an embodiment of the invention is illustrated. The system 110 includes a server 112. In other embodiments, the server 112 can be any processing device including a processor and sufficient resources to perform the process of providing a rebate to a customer. The server 112 can be any processing device including a processor and sufficient resources to perform the process of providing a rebate to a customer. The server 112 is connected to an HTTP server 114. HTTP server 114 uses HTTP or any other appropriate stateless protocols to communicate via a network 116 such as the Internet, with any other device connected to the network 116.

In the illustrated embodiment, user devices include personal computers 118, CE players, and mobile phones 120. In other embodiments, user devices can include consumer electronic devices such as televisions, set top boxes, video game consoles, tablets, and other devices that are capable of connecting to a server via HTTP and playing back encoded media. A storage unit 130, which can be in the form of memory, databases etc, is in communication with the network 116. Although a specific architecture is shown in FIG. 1, any of a variety of architectures including system that perform conventional processes can be utilized that enable playback devices to request portions of the top level index file and the container files in accordance with embodiments of the invention.

Some process for providing methods and systems in accordance with embodiments of this invention are executed by a user device or user mobile device. The relevant components in a playback device that can perform processes including adaptive streaming processes in accordance with embodiments of the invention are shown in FIG. 2. One skilled in the art will recognize that user device 200 may include other components that are omitted for brevity without departing from the embodiments of the invention as described. The user device 200 includes a processor 205, a non-volatile memory 210, and a volatile memory 215. The processor 205 is a processor, microprocessor, controller, or a combination of processors, microprocessor, and/or controllers that performs instructions stored in the volatile 215 or non-volatile memory 210 to manipulate data stored in the memory. The non-volatile memory 210 can store processor instructions utilized to configure the user device 200 to perform processes including processes in accordance with embodiments of the invention and/or data for the processes being utilized. In other embodiments, the user device software and/or firmware can be stored in any of a variety of non-transitory computer readable media appropriate to a specific application.

The communications network refers to any contact between the parties described and is accomplished through any suitable communication means, including, but not limited to, a telephone network, public switch telephone network, intranet, Internet, extranet, WAN, LAN, point of interaction device, point of sale device, personal digital assistant, cellular phone, kiosk terminal, automated teller machine (ATM), etc.), online communications, off-line communications, wireless communications, satellite communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

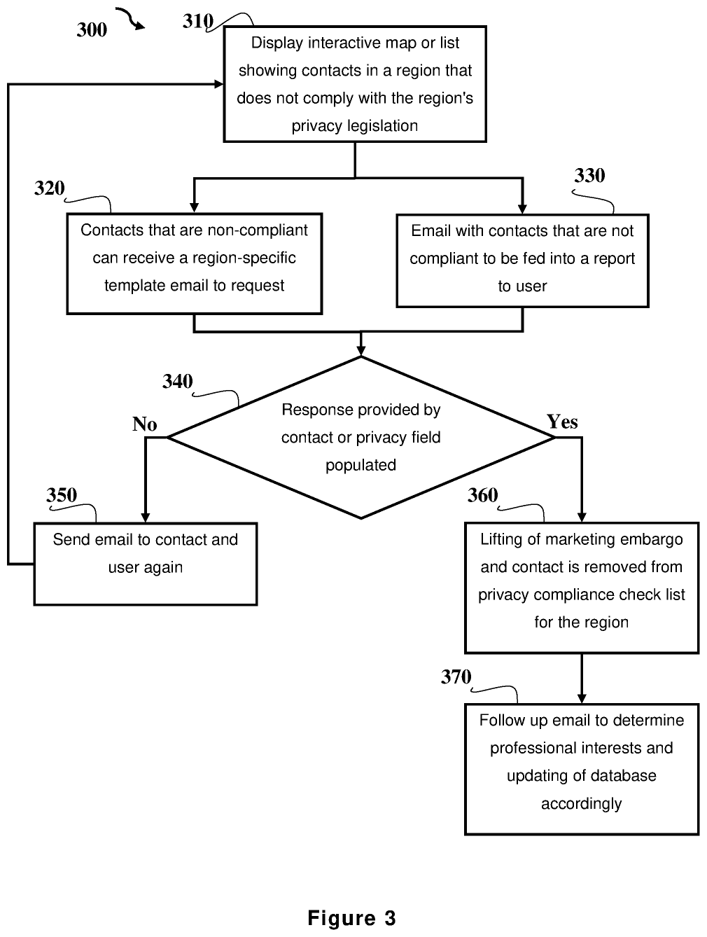

FIG. 3 illustrates a high-level flow chart of operations illustrating logical operational steps of a method 300 for managing consent for a client record management system, in accordance with the disclosed embodiments. It can be appreciated that each of the steps or logical operations of the method 300 depicted in FIG. 3 can be implemented by executing a program instruction or a group of instructions in the record management system.

The method 300 begins with a display of an interactive map or a list that shows clients or contacts in a region, area, country, city or state that do not comply with the relevant legislation concerning privacy 310. Upon selection by a user of the non-compliant region, an email can be generated the follows a template which requests for privacy compliance and this process can be automated 320. The email sent would indicate and request for a response from the client or contact, for example “To comply with Canada's Anti-Spam Legislation (CASL), we would like to continue to invite you to our events and send you alerts and newsletters that relate to our services that you are interested in. Please click on the “Yes, please continue to send me material” link below indicating that we have your consent to send event invites and publications.” When the contact clicks on the appropriate link, the “Expressed Consent” field in the record or contact record would store the date when consent received is completed for the contact. This date can then be used to calculate the expiry of the consent based on that region. Various template emails can be generated for specific regions, areas, countries, cities or states, depending on the requirement of the user. The template email can include a short questionnaire to determine the areas of interest of the contact. In a separate step, a report can be generated based on email with contacts that are not compliant 330. This report is generated by on the “Expressed Consent” field being populated in the record for the contact in the system when the region in the World Map is selected, with an indication or display for contacts that do not have the Expressed Content field populated. The report can also show contacts that do not have the Expressed Content field populated. This triggers a response from the client or contact 340, and the user can choose to send a follow up email to the client or contact 350. Once permission from the contact is received, the marketing embargo, which by default is on for any contact, is lifted 360. Internally, the system may set this field to null, off position, or its equivalent. A follow up email may be sent (if not sent in the template email) 370, based on the populated fields, to determine the professional interests of the contact and to add the contact to publications and functions lists based on these by updating the client record database accordingly.

Each contact's record can have a countdown based on the rules according to region, area, or country. This would define the number off days remaining before the contact would be requested to confirm their assent or accord to being on the list in compliance with privacy laws. This privacy compliance countdown can be displayed as a number within a circle for easy reference on the system. The colour of the number and/or circle can reflect the number of days remaining, where red means less than 30 days, orange is 30-60 days remaining and green for anything more than 60 days. The number can be displayed in a different font or style to further accentuate and highlight in the display.

With privacy legislation still in a state of development, some countries are only starting to implement it while others are already amending the laws as technology in this area evolves. This means that legislation may come into force or changed after the database has been populated and the various privacy rule would have to be updated, and/or addition or amendment to the email template. This would require an update to the system rules regarding the relevant region, area or country, instead of individual records, enable ease of maintenance and updates.

When a bounced email is received, the client record would be updated to reflect this and trigger actions to clarify or remove the wrong data. The marketing effort or material should also include an option or link to opt out of receiving any further information and the system would need to update the client record accordingly.

As understood by one of ordinary skill in the art, the present invention can be implemented with special purpose computers, devices, and servers that are programmed to implement the embodiments described herein. Further, the system according to the embodiments disclosed herein is able accommodate many more combinations and permutations, or any other future electronic payment methods. For example, the system according to the embodiments disclosed herein can accommodate cloud based or app based record management system as well.

Thus, the present invention has been fully described with reference to the drawing figures. Although the invention has been described based upon these preferred embodiments, to those of skill in the art, certain modifications, variations, and alternative constructions would be apparent, while remaining within the spirit and scope of the invention. In order to determine the metes and bounds of the invention, therefore, reference should be made to the appended claims.

1. A method of verifying a client record for privacy compliance, the method comprising:
accessing, by at least one processor, a database comprising a plurality of client records;
retrieving, by the at least one processor, a list of non-compliant client records from the database;
displaying, by the at least one processor, the list of non-compliant client records based on a category;
selecting, by the at least one processor, a non-compliant client record from the displayed list of non-compliant client records;
sending, by the at least one processor, a template email to an email address in the selected non-compliant client record;
receiving, by the at least one processor, a reply in response to the sending of the template email to the email address in the selected non-compliant client record, wherein the reply comprises a consent; and
sending, by the at least one processor, a subsequent communication to the email address in the selected non-compliant client record in response to the receiving the reply.

2. The method of claim 1, wherein the subsequent communication is a confirmatory email.

3. The method of claim 1, wherein the subsequent communication comprises a questionnaire configured to determine an interest area and update a consent status for the selected non-compliant client record in the database.

4. The method of claim 1, wherein the template email comprises a questionnaire configured to determine an interest area and update a consent status for the selected non-compliant client record in the database.

5. The method of claim 1, wherein the category is one of a region, a country, an area, a city, or a state.

6. The method of claim 1, wherein the retrieving further comprising retrieving the list of non-compliant client records based on a field in each client record corresponding to a time period since a previous consent was obtained for the respective client record.

7. The method of claim 1, further comprising:
determining, by the at least one processor, a privacy compliance countdown number for a complaint client record in the plurality of client records; and
displaying, by the at least one processor, the privacy compliance countdown number for the complaint client record based on a time period since a previous consent was obtained for the compliant client record, wherein the privacy compliance countdown number defines a number of days remaining before the complaint client record becomes non-compliant, and wherein the countdown number is highlighted using a colour, font, or style.

8. A system of verifying a client record for privacy compliance, the system comprising:
a memory; and
at least one processor coupled to the memory and configured to:
access a database comprising a plurality of client records to retrieve a list of non-compliant client records;
retrieve a list of non-compliant client records from the database;
display the list of non-compliant client records filtered based on a category;
select a non-compliant client record from the displayed list of non-compliant client records;
send a template email to an email address in the selected non-compliant client record;
receive a reply in response to the sending of the template email to the email address in the selected non-compliant client record wherein the reply comprises a consent; and
send a subsequent communication to the email address in the selected non-compliant client record in response to the receiving the reply.

9. The system of claim 8, wherein the subsequent communication is a confirmatory email.

10. The system of claim 8, wherein the subsequent communication comprises a questionnaire configured to determine an interest area and update a consent status for the selected non-compliant client record in the database.

11. The system of claim 8, wherein the template email comprises a questionnaire configured to determine an interest area and update a consent status for the selected non-compliant client record in the database.

12. The system of claim 8, wherein the category is one of a region, a country, an area, a city, or a state.

13. The system of claim 8, wherein to retrieve the at least one processor is further configured to retrieve the list of non-compliant client records based on a field in each client record corresponding to a time period since a previous consent was obtained for the respective client record.

14. The system of claim 13, wherein the least one processor is further configured to:
determine a privacy compliance countdown number for a complaint client record in the plurality of client records; and
display the privacy compliance countdown number for the complaint client record based on a time period since a previous consent was obtained for the compliant client record, wherein the privacy compliance countdown number defines a number of days remaining before the complaint client record becomes non-compliant, and wherein the countdown number is highlighted using a colour, font, or style.

15. A non-transitory computer-readable medium having instructions stored thereon that, when executed by at least one computing device, causes the at least one computing device to perform operations comprising:
accessing a database comprising a plurality of client records;
retrieving a list of non-compliant client records from the database;
displaying the list of non-compliant client records based on a category;
selecting a non-compliant client record from the displayed list of non-compliant client records;
sending a template email to an email address in the selected non-compliant client record;
receiving a reply in response to the sending of the template email to the email address in the selected non-compliant client record, wherein the reply comprises a consent; and
sending a subsequent communication to the email address in the selected non-compliant client record in response to the receiving the reply.

16. The non-transitory computer-readable medium of claim 15, wherein the subsequent communication is a confirmatory email.

17. The non-transitory computer-readable medium of claim 15, wherein the subsequent communication comprises a questionnaire configured to determine an interest area and update a consent status for the selected non-compliant client record in the database.

18. The non-transitory computer-readable medium of claim 15, wherein the category is one of a region, a country, an area, a city, or a state.

19. The non-transitory computer-readable medium of claim 15, wherein the retrieving further comprises retrieving the list of non-compliant client records based on a field in each client record corresponding to a time period since a previous consent was obtained for the respective client record.

20. The non-transitory computer-readable medium of claim 20, wherein the operations further comprise:
determining a privacy compliance countdown number for a complaint client record in the plurality of client records; and
displaying the privacy compliance countdown number for the complaint client record based on a time period since a previous consent was obtained for the compliant client record, wherein the privacy compliance countdown number defines a number of days remaining before the complaint client record becomes non-compliant, and wherein the countdown number is highlighted using a colour, font, or style.
